(19) United States
(12) Patent Application Publication
(10) Pub. No.: US 2025/0272903 A1
(43) Pub. Date: Aug. 28, 2025

(54) USING SPATIAL RELATIONSHIPS FOR ANIMATION RETARGETING

(71) Applicant: NVIDIA Corporation, Santa Clara, CA (US)

(72) Inventors: Evgenii Tumanov, Cambridge (GB); Ivan Afanasev, Yerevan (AM); Dmitry Korobchenko, London (GB); Lina Halper, Raleigh, NC (US); David Sebastian Minor, Vancouver (CA)

(21) Appl. No.: 18/589,188

(22) Filed: Feb. 27, 2024

(51) Int. Cl. G06T 13/40

(52) U.S. Cl. CPC G06T 13/40

(57) ABSTRACT

In various examples, using spatial relationships for animation retargeting in digital avatar systems and applications is described herein. Systems and methods are disclosed that determine constraints using first points (e.g., first vertices) associated with joints and/or a mesh of a source character and second points (e.g., second vertices) associated with joints and/or a mesh of a target character. As described herein, the constraints may include, but are not limited to, one or more of deformation constrains, interaction constraints, feet constraints, and angle constraints. Systems and methods are further disclosed that then use the constraints when performing optimization for animation retargeting of the target character. In some examples, the optimization is performed in vertex space, performed with respect to joints (e.g., rotations and/or transformations of the joints), and/or performed using one or more techniques, such as gradient descent.

### BACKGROUND

Many applications, such as gaming applications, interactive applications, communications applications, multimedia applications, and/or the like, use animated characters or digital avatars that interact with users of the applications and/or other animated characters within the applications. As such, animation retargeting techniques have been developed for causing target characters to be animated (e.g., move, act, etc.) similar to source characters that may be controlled, animated, and/or authored. For instance, some conventional techniques assume that a source character's skeleton and a target character's skeleton include the same hierarchy, where the characters are represented using primitive shapes and/or meshes. The skeleton hierarchy may then be used to animate the target character according to the motion of the source character. However, these conventional techniques may not adequately support arbitrary meshes and/or joint hierarchies associated with the characters. Additionally, other conventional approaches use quadratic programming for optimizing the characters, which may require large amounts of computing resources when performing animation retargeting.

As such, other conventional techniques operate at a mesh level by controlling the surfaces of the characters directly, such as at the locations of the vertices on the meshes. To do this accurately, these conventional techniques require precise correspondence between points on the source character's mesh and points on the target character's mesh. However, these conventional techniques do not consider the source character's skeleton (e.g., joints) and/or the target character's skeleton (e.g., joints) when performing optimization, which is not ideal as common three-dimensional animation pipelines work in joints transforms terms and not surface points terms. As a result, the artists of these techniques have to project the solution back to the joints transforms space. Additionally, these conventional techniques require processing all vertices on the meshes of the characters, which may again require large amounts of computing resources when performing the animation retargeting.

### SUMMARY

Embodiments of the present disclosure relate to using spatial relationships for animation retargeting in digital avatar systems and applications. Systems and methods are disclosed that determine constraints using first points (e.g., first vertex position vectors) associated with joints and/or a mesh (e.g., points and/or vertex position vectors sampled on the mesh) of a source character and second points (e.g., second vertex position vectors) associated with joints and/or a mesh (e.g. points and/or vertex position vectors sampled on the mesh) of a target character. As described herein, the constraints may include, but are not limited to, one or more of deformation constraints, interaction constraints, feet constraints, and/or angle constraints. Systems and methods are further disclosed that then use the constraints when performing optimization for animation retargeting of the target character. In some examples, the optimization is performed with respect to joints (e.g., rotations and/or transformations of the joints) such as in joints transforms space and/or performed in vertex space, and/or may be performed using one or more other techniques, such as gradient descent.

In contrast to conventional systems, the systems and methods described herein, in some embodiments, are able to perform optimization using both points on joints and points on meshes of the characters. This provides more realistic animation retargeting (e.g., target character animation) as compared to both the conventional systems that perform optimization only using joint hierarchies of the characters and the conventional systems that perform optimization only using vertices of the meshes of the characters. Additionally, in contrast to the conventional systems, the described systems, in some embodiments, perform the optimization in vertex space, in joints' transforms space, and/or using specific techniques, such as gradient descent and/or more advanced modifications (e.g., Hessian optimization, etc.), which may cause the current systems execute with less latency and/or require less computing resources as compared to the conventional systems.

### BRIEF DESCRIPTION OF THE DRAWINGS

The present systems and methods for using spatial relationships for animation retargeting in digital or virtual avatar/human systems and applications are described in detail below with reference to the attached drawing figures, wherein:

FIG. 1 illustrates an example of a process for performing animation retargeting by optimizing various constraints, in accordance with some embodiments of the present disclosure;

FIG. 2 illustrates an example illustration of characters that may be used for animation retargeting, in accordance with some embodiments of the present disclosure;

FIGS. 3A-3B illustrate an example of corresponding points associated with a source character with points associated with a target character, in accordance with some embodiments of the present disclosure;

FIG. 4 illustrates an example of deformation constraints associated with animation retargeting, in accordance with some embodiments of the present disclosure;

FIG. 5 illustrates an example of interaction constraints associated with animation retargeting, in accordance with some embodiments of the present disclosure;

FIG. 6 illustrates an example of acceleration constraints associated with animation retargeting, in accordance with some embodiments of the present disclosure;

FIGS. 7A-7B illustrate examples of feet constraints associated with animation retargeting, in accordance with some embodiments of the present disclosure;

FIG. 8 illustrates an example of joint constraints associated with animation retargeting, in accordance with some embodiments of the present disclosure;

FIG. 9 illustrates a flow diagram showing a method for using spatial information for animation retargeting, in accordance with some embodiments of the present disclosure;

FIG. 10 illustrates a flow diagram showing a method for determining that points associated with a source character correspond to points associated with a target character, in accordance with some embodiments of the present disclosure;

FIG. 11 illustrates a flow diagram showing a method for using spatial information for animation retargeting between characters and objects, in accordance with some embodiments of the present disclosure;

FIG. 12 is a block diagram of an example content streaming system suitable for use in implementing some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

Systems and methods are disclosed related to using spatial information for animation retargeting in digital or virtual avatar/human systems and applications. For instance, a system(s) may receive first data representing a source character and second data representing a target character. As described herein, the source character may include a character that is performing animation, such as motion, and the target character may include a character that is copying (e.g., mimicking) the animation of the source character. In some examples, the target character may include one or more characteristics that are similar to one or more characteristics of the source character. Additionally, or alternatively, in some examples, the target character may include one or more characteristics that differ from one or more characteristics of the source character. As described herein, a characteristic may include, but is not limited to, a type of character, a height, a weight, a number of joints, locations of the joints, types of joints, and/or any other characteristic that may be used to create a character.

The system(s) may then determine points associated with the source character that correspond to points associated with the target character. To determine the correspondence between the points, the system(s) may initially determine one or more first points that are associated with one or more joints of the source character and one or more second points that are associated with one or more corresponding joints of the target character. In some examples, the system(s) determines the first point(s) associated with the joint(s) and/or the second point(s) associated with the corresponding joint(s) using inputs (e.g., tags) from one or more users while, in other examples, the system(s) determines the first point(s) associated with the joint(s) and/or the second point(s) associated with the corresponding joint(s) based at least on processing the characters. The system(s) may then use the first point(s) and the second point(s) to determine one or more third points associated with a first mesh of the source character that correspond to one or more fourth points associated with a second mesh of the target character. As such, the system(s) may use a smaller subset of the points to create an initial association between the two characters, and may then use the smaller subset to match additional (e.g., the remaining) points.

For example, to determine a correspondence between points, the system(s) may determine a first vector that is between a first point associated with a joint of the source character and a third point that is located on the first mesh of the source character. The system(s) may also determine one or more second vectors that are between a second point associated with a corresponding joint of the target character and one or more fourth points that are located on the second mesh of the target character. The system(s) may then determine that one of the fourth point(s) corresponds to the third point using the second vector(s) and the first vector. For example, the system(s) may determine that a fourth point that includes a closest vector to the first vector corresponds to the third point. The system(s) may then continue to perform these processes for any number of points associated with the source character and/or any number of points associated with the target character.

The system(s) may then use the correspondences to determine constraints, where the constraints may be preserved when performing optimization for the animation retargeting. In some examples, the constraints may include one or more deformation constraints associated with spatial information between points on the characters. For instance, the system(s) may identity a first set of points on the source character that satisfy one or more thresholds, such as one or more distance thresholds (which are described in more detail herein). The system(s) may then identify a second set of points on the target character that corresponds to the first set of points. Additionally, the system(s) may determine the deformation constraint(s) based at least on first vertex positions and/or a first vector associated with the first set of points and second vertex positions and/or a second vector associated with the second set of points. For instance, the deformation constraint(s) may be associated with causing the second vector to be similar to the first vector. The system(s) may then use similar processes for additional sets of points on the source character and/or the target character.

In some examples, the constraints may include one or more interaction constraints associated with relationships between the characters and objects. For instance, the system(s) may identity a first set of points between the source character and an object that satisfy one or more thresholds, such as one or more distance thresholds (which are described in more detail herein). The system(s) may then identify a second set of points between the target character and a corresponding object, where the second set of points corresponds to the first set of points. Additionally, the system(s) may determine the interaction constraint(s) based at least on first vertex positions and/or a first vector associated with the first set of points and second vertex positions and/or a second vector associated with the second set of points. For instance, the interaction constraint(s) may be associated with causing the second vector to be similar to the first vector. The system(s) may then use similar processes for additional sets of points between the characters and the objects.

In some examples, the constraints may include one or more acceleration constraints associated with the target character. For instance, the system(s) may determine the acceleration constraint(s) based on the vertex positions associated with one or more points associated with the target character over multiple time instances (e.g., between multiple frames). In some examples, the constraints may include one or more joint constraints associated with angles between pairs of joints. For instance, the system(s) may determine the joint constraint(s) based at least on first vertex positions and/or a first vector between a first set of points associated with two joints of the source character and/or second vertex positions and/or a second vector between a second set of points associated with the same two joints of the target character. For instance, the joint constraint(s) may be associated with causing the second vector to be similar to (e.g., include a similar angle as) the first vector. The system(s) may then use similar processes for additional sets of points associated with additional joints of the source character and/or the target character.

In some examples, the constraints may include one or more foot or feet constraints associated with the characters. For a first example, the feet constraint(s) may be based at least on causing one or more vertex positions of one or more points associated with a first foot of the target character to be substantially similar to one or more vertex positions of one or more corresponding points associated with the corresponding foot of the source character and/or based at least on causing a second foot of the target character to include a substantially similar orientation (e.g., in the y-direction) as the corresponding foot of the source character. For a second example, the foot constraint(s) may be based at least on vertex positions of one or more points associated with one or more feet of the target character over multiple time instances (e.g., between multiple frames), such as when the corresponding feet of the source character remain substantially static between the multiple time instances. Although described as feet primarily herein, the constraint may be applied to other features, such as fins, hooves, flippers, etc. of any type of character/avatar/etc.

The system(s) may then perform the optimization using one or more equations that use one or more of the constraints described herein. In some examples, the equation(s) may include a similar form for one or more (e.g., each) of the constraint(s) used for optimization. In some examples, the equation(s) may be optimized with respect to one or more variables, such as a variable associated with one or more degrees of freedom corresponding to one or more joints of the target character. As described herein, the degree(s) of freedom associated with a joint may be associated with a translation and/or rotation associated with the joint. In some examples, the equation(s) may be associated with one or more optimization techniques, such as gradient descent. For example, the optimization may be performed with respect to the variable(s) using gradient descent.

As described herein, the system(s) may perform the optimization for one or more offline applications and/or one or more online applications. In some examples, the system(s) may perform the optimization for offline applications by performing these formulations for multiple frames (e.g., every frame) at a single instance. In some examples, the system(s) may perform the optimization for online applications by performing the formulations for one or more frames at different instances in time as the system(s) continues to generate new frames. Additionally, in some examples, such as when performing the online applications, the equation(s) used for optimization may include one or more additional terms. For example, the equation(s) may include one or more regulations terms in order to improve motion associated with the target character between frames, such as to reduce artifacts and/or jitter. Additionally, the optimization may be performed at each frame without any information about motion coming from future frames and/or the optimization may not rely on future vertices' positions. The system(s) may then cause output of content associated with the source character and/or the target character. For instance, the output may include poses of the target character (e.g., joints transform for the target character that matches the source character) at different frames, where the frames are associated with different time instances. For example, the output may include a video of the target character being animated similar to the source character.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, gaming, 3D content (e.g., games, entertainment, media, etc.), cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

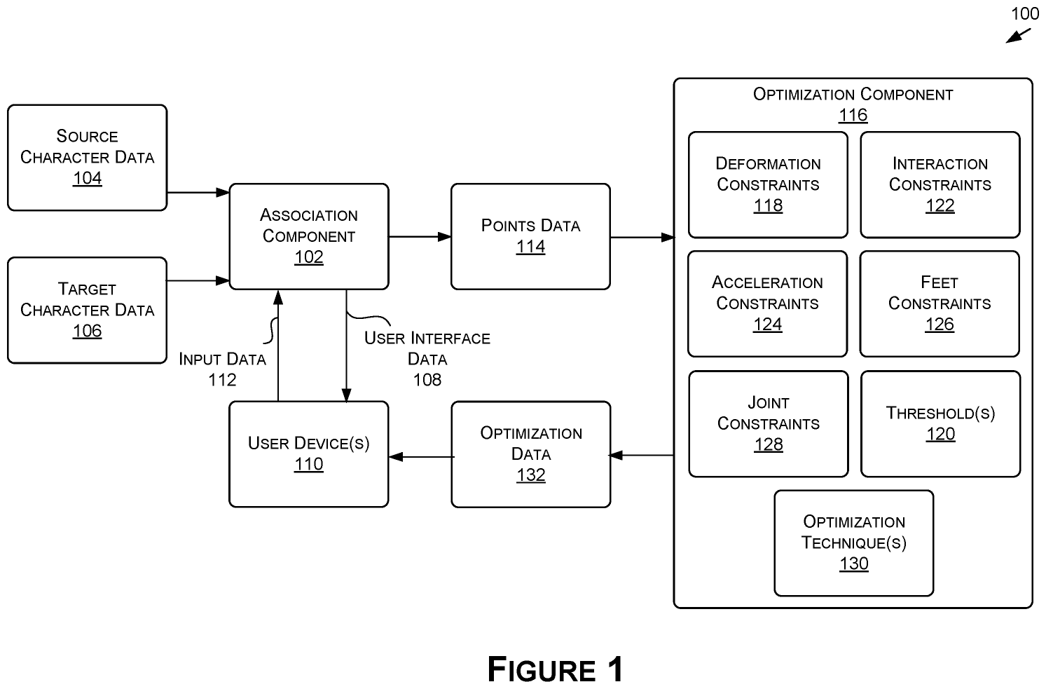

With reference to FIG. 1, FIG. 1 illustrates an example of a process 100 for performing animation retargeting by optimizing various constraints, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include an association component 102 receiving source character data 104 representing a source character and target character data 106 representing a target character. As described herein, the source character may include a character/avatar/digital human/etc. that is performing animation, such as motion, and the target character may include a character that is copying (e.g., mimicking) the animation of the source character. In some examples, the target character may include one or more characteristics that are similar to one or more characteristics of the source character. Additionally, or alternatively, in some examples, the target character may include one or more characteristics that differ from one or more characteristics of the source character. As described herein, a characteristic may include, but is not limited to, a type of character, a height, a weight, a number of joints, locations of the joints, types of joints, and/or any other characteristic that may be used to create a character.

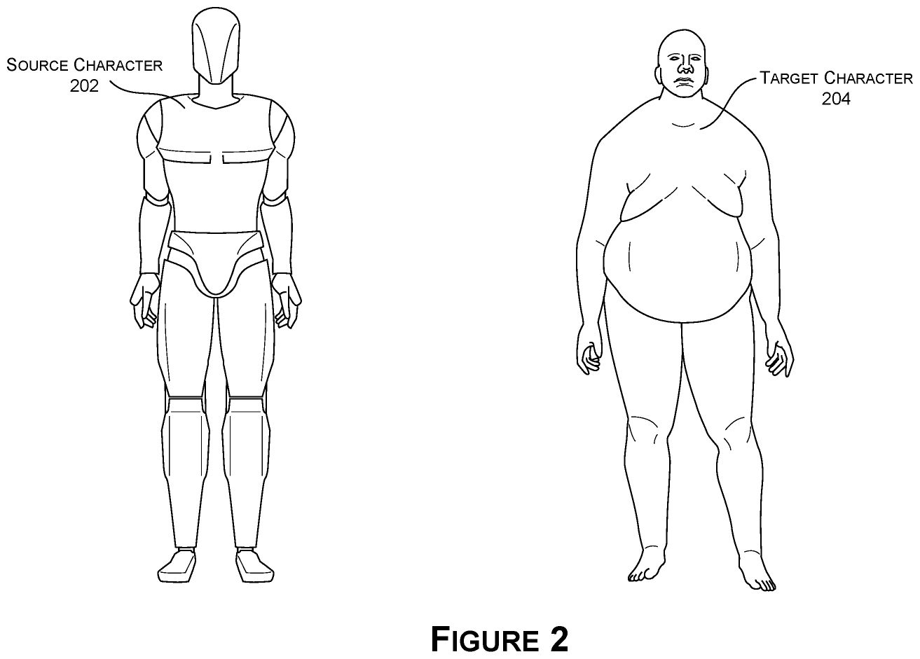

For instance, FIG. 2 illustrates an example illustration of characters that may be used for animation retargeting, in accordance with some embodiments of the present disclosure. As shown, the animation retargeting may include using a source character 202 (which may be represented by the source character data 104) and a target character 204 (which may be represented by the target character data 106). While the example of FIG. 2 illustrates the target character 204 as including similar characteristics as the source character 202, such similar parts (e.g., a head, two arms, a torso, two legs, etc.), a similar number of joints, and/or similar locations of the joints, in other examples, a target character may include different characteristics as compared to a source character. For instance, in other examples, a target character may include different parts, a different number of joints, different locations of the joints, and/or so forth.

Referring back to the example of FIG. 1, the process 100 may include the association component 102 determining points associated with the source character that correspond to points associated with the target character. In some examples, the association component 102 may use any technique to determine the points associated with the source character that correspond to the points associated with the target character. Additionally, as described herein, the corresponding points may be associated with joints of the character, meshes of the character, objects that the characters are interacting with, and/or any other points.

For an example of how the association component 102 may determine the correspondence between the points, the association component 102 may initially determine one or more first points that are associated with one or more joints of the source character and one or more second points that are associated with one or more corresponding joints of the target character. In some examples, the system(s) determines the first point(s) associated with the joint(s) and/or the second point(s) associated with the corresponding joint(s) using inputs (e.g., tags) from one or more users while, in other examples, the system(s) determines the first point(s) associated with the joint(s) and/or the second point(s) associated with the corresponding joint(s) based at least on processing the characters. In some examples, the tags may then be used to transfer correspondence between the joints onto correspondences between the mesh surfaces.

For instance, and as shown, the association component 102 may generate user interface data 108 representing a user interface that includes at least an illustration of the source character and an illustration of the target character (e.g., similar to the example of FIG. 2). One or more user devices 110 may then use the user interface data 108 to present the user interface to one or more users. The user(s) may then use the user device(s) 110 to provide inputs, which may be represented by input data 112, wherein the inputs add a tag to a joint of the source character and a similar tag to a corresponding joint of the target character. For example, if the joint is associated with a right elbow, then the user(s) may provide a “right elbow” tag for the source character and another “right elbow” tag for the target character. In response, the association component 102 may cause a point associated with the joint on the source character to correspond to a point of the corresponding joint on the target character. This process may then repeat for any number of joints associated with the source character and/or the target character.

In some examples, the user(s) may use any technique when providing the inputs. For a first example, the user device(s) 110 may include an input device, such as a keyboard, a joystick, a mouse, a button, a touch display, and/or the like that the user(s) is able to use to provide the inputs. For a second example, the user device(s) 110 may include one or more microphones that the user device(s) 110 uses to generate audio data representing speech, such as voice commands, associated with the inputs. In such an example, the user device(s) 110 may use one or more machine learning models, one or more neural networks, one or more large language models (LLMs), and/or any other component to process the audio data in order to interpret the commands as inputs.

The association component 102 may then use the first point(s) and the second point(s) to determine one or more third points on a mesh of the source character that correspond to one or more fourth points on a mesh of the target character. For example, to determine a correspondence between points, the association component 102 may determine a first vector that is between a first point associated with a joint of the source character and a third point that is located on the mesh of the source character. The association component 102 may also determine one or more second vectors that are between a second point associated with a corresponding joint of the target character and one or more fourth points that are located on the mesh of the target character. The association component 102 may then determine that one of the fourth point(s) corresponds to the third point using the second vector(s) and the first vector. For example, the association component 102 may determine that a fourth point that includes a closest vector to the first vector corresponds to the third point. The association component 102 may then continue to perform these processes for any number of points associated with the source character and/or any number of points associated with the target character.

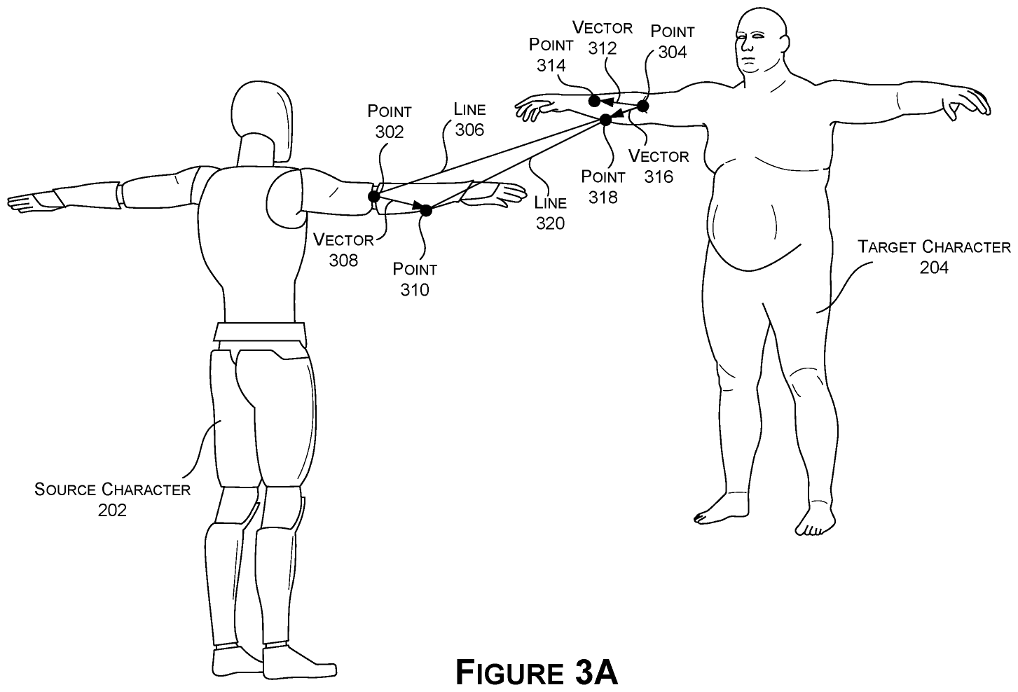

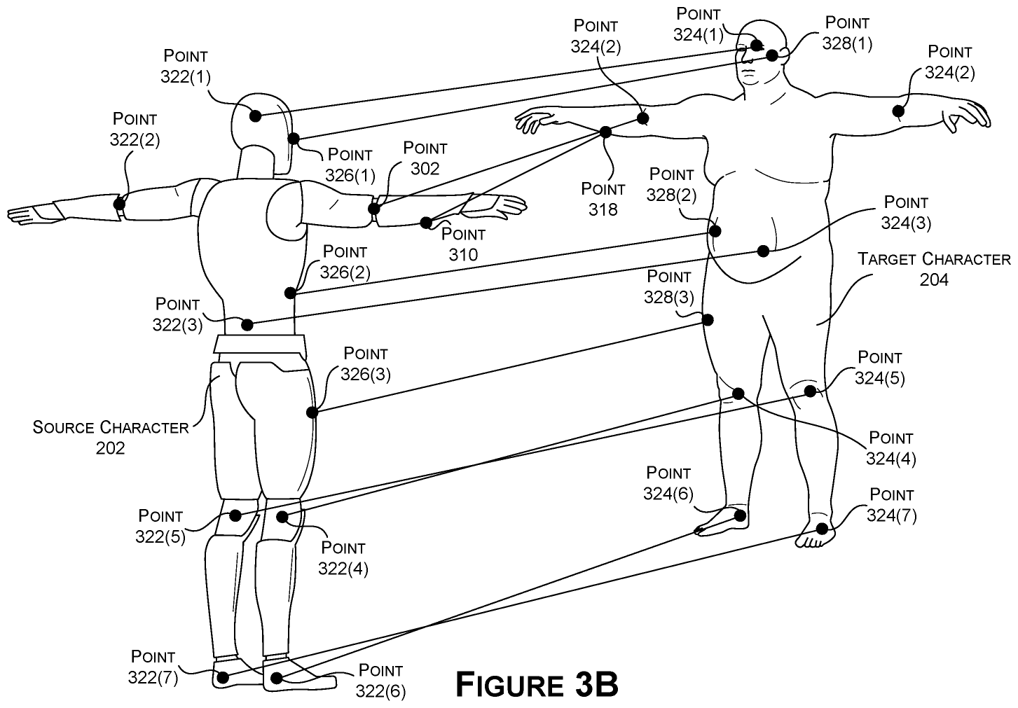

For instance, FIGS. 3A-3B illustrate an example of corresponding points associated with the source character 202 with points associated with the target character 204, in accordance with some embodiments of the present disclosure. As shown by the example of FIG. 3A, a user may initially tag a first point 302 associated with a joint of the source character 202, where the first point 302 is grey since it is on the skeleton of the source character 202. The user may then tag a second point 304 associated with a corresponding joint on the target character 204, where the second point 304 is also grey since it is on the skeleton of the target character 204. Based on those inputs, the association component 102 may determine that the first point 302 corresponds to the second point 304, which is indicated by a line 306.

The association component 102 may then determine a first vector 308 that is between a third point 310 on the mesh of the source character 202 and the first point 302 (e.g., the closest joint point), where the third point 310 is black since it is located on the mesh of the source character 202. Additionally, the association component 102 may determine at least a second vector 312 that is between a fourth point 314 on the mesh of the target character 204 and the second point 304 and a third vector 316 that is between a fifth point 318 on the mesh of the target character 204 and the second point 304, where the points 314 and 318 are also black since they are located on the mesh of the target character 204. The association component 102 may then use the first vector 308, the second vector 312, and the third vector 316 to determine whether the fourth point 314 or the fifth point 318 corresponds to the third point 310. For instance, and in the example of FIG. 3A, the association component 102 may determine that the fourth point 314 corresponds to the third point 310 based at least on the second vector 312 being more similar to the first vector 308 than the third vector 316 is to the first vector 308, where the correspondence is indicated by a line 320.

This process may then continue to repeat for any number of points associated with the joints and/or the mesh of the source character 202 and/or any number of points associated with the joints and/or the mesh of the target character 204. For instance, the example of FIG. 3B further illustrates the association component 102 determining that points 322(1)-(7) associated with joints of the source character 202 respectively correspond to points 324(1)-(7) associated with corresponding joints of the target character 204. Additionally, the association component 102 determines that points 326(1)-(3) associated with the mesh of the source character 202 respectively correspond to points 328(1)-(3) associated with the mesh of the target character 204. While the example of FIG. 3B illustrates a specific number of points, in other examples, the association component 102 may perform these processes to determine that any number of points associate with the source character 202 correspond to any number of points associated with the target character 204. For example, the association component 102 may determine correspondences between one point, ten points, one hundred points, one thousand points, and/or any other number of points.

As described herein, while this is just one example technique of how the association component 102 may determine the associations between the points of the source character 202 and the points of the target character 204, in other examples, the association component 102 may use any other technique.

Referring back to the example of FIG. 1, the process 100 may include the association component 102 generating and/or outputting points data 114. The points data 114 may represent the positions (e.g., vertex position vectors) of the points associated with the skeleton and/or mesh of the source character, the tags for the points associated with the source character, the positions (e.g., vertex position vectors) of the points associated with the skeleton and/or mesh of the target character, the tags for the points associated with the target character, the correspondences between the points associated with the source character and the points associated with the target character, and/or any other information associated with the points of the characters. The process 100 may then include an optimization component 116 using at least the points data 114 to perform one or more of the optimization techniques described herein in order to perform animation retargeting with respect to the target character.

As described herein, the optimization component 116 may determine constraints, where the constraint may be preserved when performing optimization for the animation retargeting. For instance, in some examples, the constraints may include one or more deformation constraints 118 associated with spatial information between points on the characters. For instance, the optimization component 116 may identity a first set of points on the source character that satisfy one or more thresholds 120, such as one or more distance thresholds 120. For example, to identify the first set of points on the source character, the optimization component 116 may use a vertex position of a first point and a vertex position of a second point to determine a distance d between the points. The optimization component 116 may then determine whether the first point and the second point should be included in the first set of points based at least on whether the distance d satisfies (e.g., is less than) the following:

$$d < ε \qquad ( 1 )$$

$$d / d 0 < γ \qquad ( 2 )$$

In equations (1) and (2), ε and γ include threshold distances 120 and d0 includes a distance between the same two points when the source character and/or the target character are in a set pose (e.g., a default pose and/or initial pose), such as the pose illustrated in FIGS. 3A-3B. In some examples, the threshold distance ε is similar to the threshold distance γ while, in other examples, the threshold distance ε is different than the threshold distance γ. Additionally, in some examples, the optimization component 116 may determine that the points should be included in the first set of points based at least on satisfying one of the threshold distances while, in other examples, the optimization component 116 may determine that the points should be included in the first set of points based at least on satisfying both of the threshold distances.

The optimization component 116 may then identify a second set of points on the target character that corresponds to the first set of points (e.g., using the correspondences determined by the correspondence component 102). Additionally, the optimization component 116 may determine the deformation constraint(s) 118 based at least on first vertex positions and/or a first vector associated with the first set of points and second vertex positions and/or a second vector associated with the second set of points. For instance, the deformation constraint(s) 118 may be associated with causing the second vector to be similar to the first vector using the following equation:

$${‖ {\vec{V}}_{A} - {\vec{V}}_{B} - ‖}^{2} \qquad ( 3 )$$

In equation (3), \vec{V}_{A} and \vec{V}_{B} are the vertex positions of the points included in the second set of points and \vec{β} is the vector between the points in the first set of points. As described herein, a vector position may include (Vₓ, V_{y}, V_{z}). The optimization component 116 may then use similar processes to identify one or more additional sets of points on the source character and/or the target character.

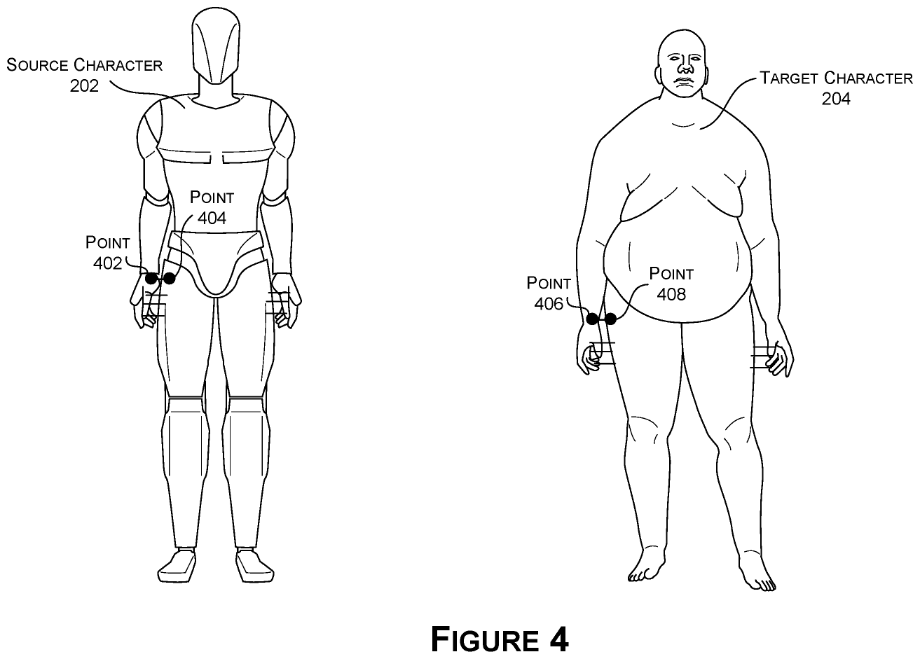

For instance, FIG. 4 illustrates an example of deformation constraints associated with animation retargeting, in accordance with some embodiments of the present disclosure. As shown, the optimization component 116 may perform one or more of the processes described herein to identity a first set of points that includes a first point 402 and a second point 404 associated with the source character 202. The optimization component 116 may then perform one or more of the processes described herein to identify a second set of points that includes a third point 406 and a fourth point 408 associated with the target character 204, where the third point 406 corresponds to the first point 402 and the fourth point 408 corresponds to the second point 404. The deformation constraints may then be associated with causing a distance between the second set of points to remain similar to a distance between the first set of points and/or that a vector between the second set of points includes a same direction as a vector between the first set of points. In other words, the deformation constraints may cause the vector between the second set of points to be similar to the vector between the first set of points. Additionally, similar processes may be performed for additional sets of points associated with the source character 202 and/or additional sets of points associated with the target character 204, which is illustrated by the lines in FIG. 4.

Referring back to the example of FIG. 1, the constraints may include one or more interaction constraints 122 associated with spatial information between points associated with the characters and points associated with objects for which the characters are interacting. For instance, the optimization component 116 may identity a first set of points that includes a first point associated with the source character and a second point associated with an object, where the first set of points is identified based at least on the first set of points satisfying one or more distance thresholds 120. For example, to identify the first set of points, the optimization component 116 may use a vertex position of the first point associated with the source character and a vertex position of the second point associated with the object to determine a distance dᵢ between the points. The optimization component 116 may then determine whether the first point and the second point should be included in the first set of points based at least on whether the distance dᵢ satisfies (e.g., is less than) the following:

$${d}_{i} < β \qquad ( 4 )$$

In equation (4), β includes a threshold distance 120. In some examples, the threshold distance β is similar to one or more of the threshold distance ε or the threshold distance γ while, in other examples, the threshold distance β is different than the threshold distance ε and the threshold distance γ.

The optimization component 116 may then identify a second set of points that includes a third point associated with the target character and a fourth point associated with a corresponding object, where the second set of points corresponds to the first set of points. Additionally, the optimization component 116 may determine the interaction constraint(s) 122 based at least on first vertex positions and/or a first vector associated with the first set of points and second vertex positions and/or a second vector associated with the second set of points. For instance, the interaction constraint(s) 122 may be associated with causing the second vector to be similar to the first vector using the following equation:

$${‖ {\vec{V}}_{AI} - {\vec{V}}_{BI} - ‖}^{2} \qquad ( 5 )$$

In equation (5), \vec{V}_{AI} and \vec{V}_{BI} are the vertex positions of the points included in the second set of points and \vec{β}_{I} is the vector between the points in the first set of points. The optimization component 116 may then use similar processes to identify one or more additional sets of points associated with the characters and the objects.

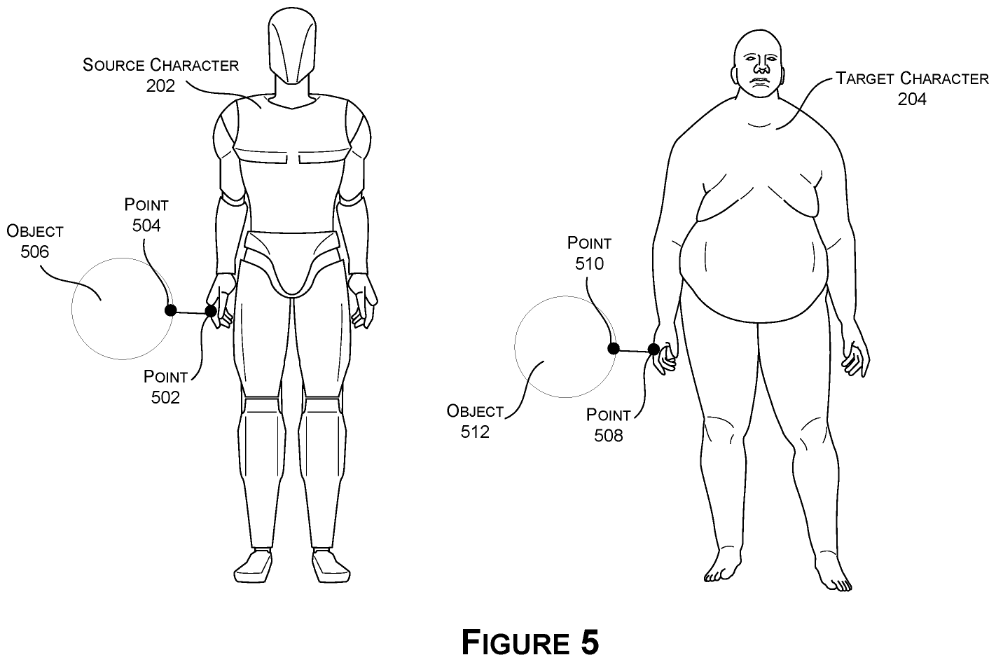

For instance, FIG. 5 illustrates an example of interactions constraints associated with animation retargeting, in accordance with some embodiments of the present disclosure. As shown, the optimization component 116 may perform one or more of the processes described herein to identity a first set of points that includes a first point 502 associated with the source character 202 and a second point 504 associated with a first object 506. The optimization component 116 may also identify a second set of points that includes a third point 508 associated with the target character 204 and a fourth point 510 associated with a second object 512. In the example of FIG. 5, the third point 508 corresponds to the first point 502, the fourth point 510 corresponds to the second point 504, and the second object 512 corresponds to the first object 506. The interaction constraints may then be associated with causing a distance between the second set of points to remain similar to a distance between the first set of points, and/or a vector between the second set of points to include a same direction as a vector between the first set of points. In other words, the interaction constraints may cause the vector between the second set of points to be similar to the vector between the first set of points. Additionally, similar processes may be performed for one or more additional sets of points associated with the source character 202 and the first object 506 and/or one or more additional sets of points associated with the target character 204 and the second object 512.

Referring back to the example of FIG. 1, the constraints may include one or more acceleration constraints 124 corresponding to one or more accelerations of one or more points associated with the target character (and/or, in some examples, the source character). For instance, and for a point associated with the target character, the optimization component 116 may determine vertex positions of the point at different time instances. In some examples, one or more time instances (e.g., each time instance) may correspond to a respective frame depicting the target character. For example, and for a current frame, the optimization component 116 may determine a first vertex position of the point at a previous frame, a second vertex position of the point at the current frame, and a third vertex position of the point at a future frame. The optimization component 116 may then determine the acceleration constraints 124 using the vertex positions. For instance, the acceleration constraints 124 may be associated with the following equation:

$${‖ {\vec{V}}_{A} ( n - 1 ) - 2 {\vec{V}}_{A} ( n ) + {\vec{V}}_{A} ( n + 1 ) - \vec{0} ‖}^{2} \qquad ( 6 )$$

In equation (6), \vec{V}_{A}(n−1) is the vertex position of the point at the previous time instance (e.g., the previous frame), \vec{V}_{A}(n) is the vertex position of the point at the current time instance (e.g., the current frame), and \vec{V}_{A}(n+1) is the vertex position of the point at the future time instance (e.g., the future frame). The optimization component 116 may then use similar processes for one or more additional points associated with the target character. In some examples, the acceleration constraint(s) 124 may be used to control the accelerations of different points and/or portions of the target character, such as to avoid jitter between frames.

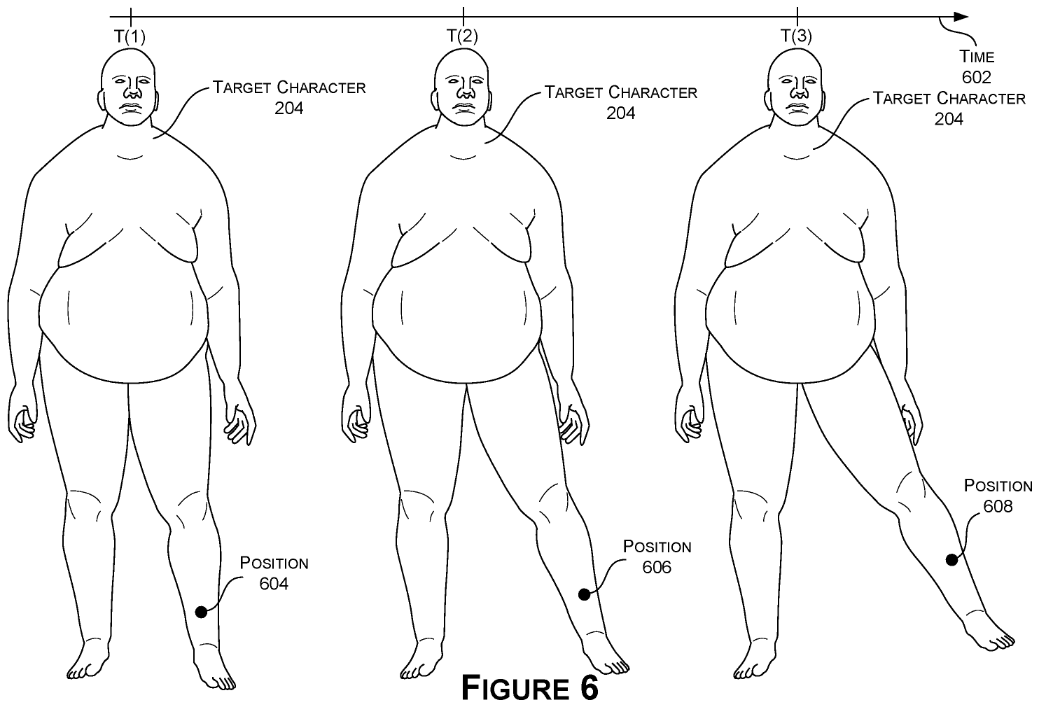

For instance, FIG. 6 illustrates an example of acceleration constraints associated with animation retargeting, in accordance with some embodiments of the present disclosure. As shown, and over a period of time 602, the optimization component 116 may determine a first vertex position 604 (e.g., \vec{V}_{A}(n−1)) of a point at a first time instance T(1), a second vertex position 606 (e.g., \vec{V}_{A}(n)) of the point at a second time instance T(2), and a third vertex position 608 (e.g., \vec{V}_{A}(n+1)) of the point at a third time instance T(3). In some examples, the first time instance T(1) is associated with a previous frame, the second time instance T(2) is associated with a current time, and the third time instance T(3) is associated with a future frame. The optimization component 116 may then use the vertex positions 604, 606, and 608 as part of the acceleration constraint(s) 124 associated with the target character 204 (e.g., using equation (6)). Additionally, in some examples, the optimization component 116 may perform similar processes for one or more additional points associated with the target character 204.

Referring back to the example of FIG. 1, the constraints may include one or more foot or feet constraints 126 associated with the motion and/or locations of one or more feet of the target character. For instance, in some examples, a first foot constraint 126 may include causing one or more points associated with a foot of the target character to include one or more same positions of one or more corresponding points associated with the same foot of the source character. For example, and for a point associated the foot of the source character, the optimization component 116 may determine a first vertex position of the point associated with the source character and a second vertex position of a corresponding point associated with the target character. For the feet constraint(s) 126, the optimization component 116 may then use the following equation:

$${‖ {\vec{V}}_{RT} - {\vec{V}}_{RS} ‖}^{2} \qquad ( 7 )$$

In equation (7), \vec{V}_{RS} is the first vertex position of the point associated with the source character and \vec{V}_{RT} is the second vertex position of the corresponding point associated with the target character. As shown, equation (7) causes the second vertex position to be similar to the first vertex position. The optimization component 116 may then use similar processes for one or more additional points associated with the source character and/or one or more additional points associated with the target character.

In some examples, a second foot constraint 126 may include causing the other foot of the target character to include a same position along one or more axes as the corresponding foot of the source character. As described herein, the orientation may be with respect to the x-direction, the y-direction, and/or the z-direction. For example, the optimization component 116 may cause the y-direction coordinates of a first point associated with the foot of the source character to be similar to the y-direction coordinates of a point associated with a corresponding foot of the target character. For instance, this foot constraint 126 may be associated with the following equation:

$${‖ {\vec{V}}_{LT} - {\vec{V}}_{LS} ‖}_{Y}^{2} \qquad ( 8 )$$

In equation (8), \vec{V}_{LS} is a first vertex position of the point associated with the source character and \vec{V}_{LT} is a second vertex position of the corresponding point associated with the target character. The optimization component 116 may then use similar processes for one or more additional points associated with the source character and/or one or more additional points associated with the target character. As such, by using these feet constraints 126, the feet of the target character may be oriented and/or may be animated similar to the feet of the source character.

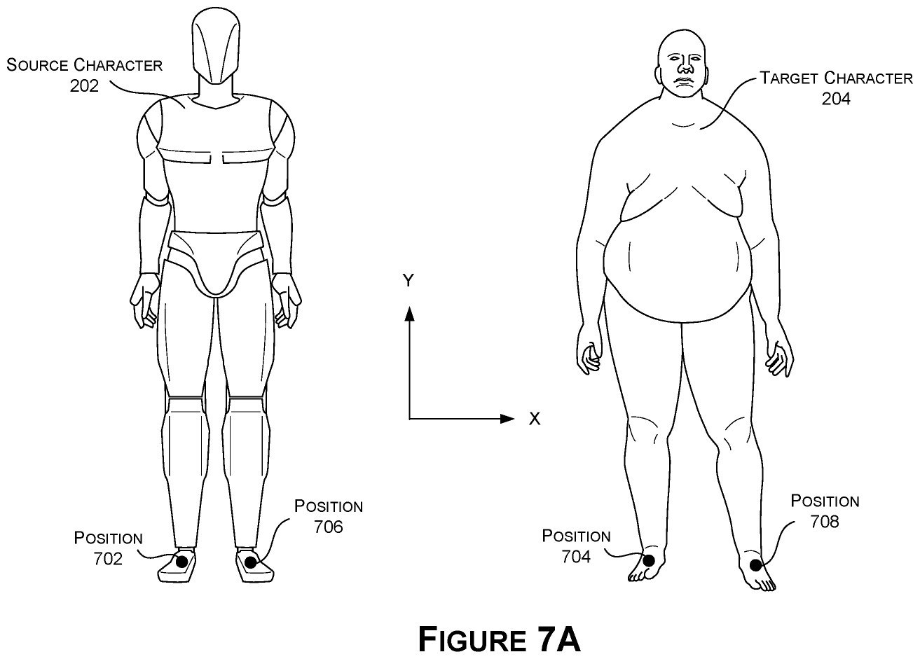

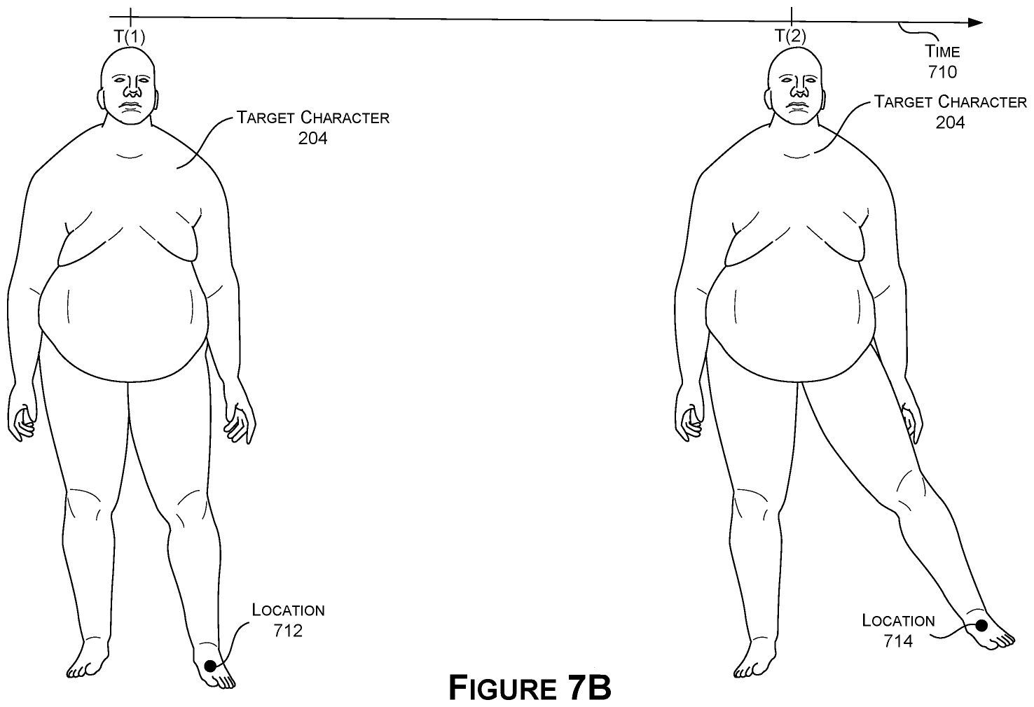

For instance, FIG. 7A illustrates an example of feet constraints associated with animation retargeting, in accordance with some embodiments of the present disclosure. As shown, the optimization component 116 may determine a first vertex position 702 (e.g., \vec{V}_{RS}) of a point associated with the source character 202 and a second vertex position 704 (e.g., \vec{V}_{RT}) of a corresponding point associated with the target character 204. The optimization component 116 may then use the vertex positions 702 and 704 as part of the feet constraints 126 that cause the foot of the target character 204 to be approximately located at a same position as the corresponding foot of the source character 202 (e.g., using equation (7)). The optimization component 116 may also determine a third vertex position 706 (e.g., \vec{V}_{LS}) of a point associated with the source character 202 and a fourth vertex position 708 (e.g., \vec{V}_{LT}) of a corresponding point associated with the target character 204. The optimization component 116 may then use the vertex positions 706 and 708 as part of the feet constraints 126 that cause the foot of the target character 204 to include an approximately same orientation as the corresponding foot of the source character 202 (e.g., using equation (8)).

Referring back to the example of FIG. 1, in some examples, a third foot constraint 126 may include restricting motion (e.g., sliding) of one or more of the feet of the target character. For example, the optimization component 116 may determine that a foot of the source character is static and/or substantially static between two time instances (e.g., between two frames). In some examples, the optimization component 116 may determine that the foot is static and/or substantially static based at least on one or more differences between one or more first vertex positions of one or more points associated with the foot at a first time instance and one or more second vertex positions of the one or more points at a second time instance satisfying (e.g., being less than) a threshold. If the optimization component 116 determines that the foot is static and/or substantially static, then the optimization component 116 may restrict the motion of the corresponding foot of the target character.

For instance, the optimization component 116 may determine a first vertex position of a point associated with the corresponding foot of the target character at the first time instance and a second vertex position of the point associated with the corresponding foot at the second time instance. The optimization component 116 may then determine this foot constraint 126 using the following:

$${‖ {\vec{V}}_{A} ( n ) - {\vec{V}}_{A} ( n - 1 ) ‖}^{2} \qquad ( 9 )$$

In equation (9), \vec{V}_{A}(n−1) is the vertex position of the point at the previous time instance (e.g., the previous frame) and \vec{V}_{A}(n) is the vertex position of the point at the current time instance (e.g., the current frame). The optimization component 116 may then use similar processes for one or more additional points associated with the target character. In some examples, this foot constraint 126 may be used in order to control movement of one or more feet of the target character, such as to avoid “sliding” between frames. In some examples, this foot constraint 126 may be used based at least on the occurrence of one or more other factors, such as when a velocity associated with a corresponding foot of the source character is less than a threshold velocity. In other words, this foot constraint 126 may be configured to keep one or more of the feet of the target character to be static when one or more corresponding feet of the source character are static.

For instance, FIG. 7B illustrates another example of feet constraints associated with animation retargeting, in accordance with some embodiments of the present disclosure. As shown, and over a period of time 710, the optimization component 116 may determine a first vertex position 712 (e.g., \vec{V}_{A}(n−1)) of a point at a first time instance T(1) and a second vertex position 714 (e.g., \vec{V}_{A}(n)) of the point at a second time instance T(2). In some examples, the first time instance T(1) is associated with a previous frame and the second time instance T(2) is associated with a current time. The optimization component 116 may then use the vertex positions 712 and 714 as part of the feet constraint(s) 126 associated with the target character 204 (e.g., using equation (9)). Additionally, in some examples, the optimization component 116 may perform similar processes for one or more additional points associated with the target character 204.

Referring back to the example of FIG. 1, the constraints may include one or more joint constraints 128 associated with maintaining angles between one or more sets of joints associated with the source character and one or more sets of corresponding joints associated with the target character. For instance, the optimization component 116 may determine a first set of points associated with joints of the source character and a second set of points associated with corresponding joints of the target character. The optimization component 116 may then determine the joint constraint(s) 128 based at least on first vertex positions and/or a first vector associated with the first set of points and second vertex positions and/or a second vector associated with the second set of points. As described herein, the joint constraint(s) 128 may be associated with causing a first angle associated with the first vector to be similar to and/or substantially similar to a second angle associated with the second vector. For instance, the optimization component 116 may determine the joint constraint(s) 128 using the following equation:

$${‖ ( {\vec{V}}_{AJ} - {\vec{V}}_{BJ} ) - ( {\vec{V}}_{CJ} - {\vec{V}}_{DJ} ) ‖}^{2} \qquad ( 10 )$$

In equation (10), \vec{V}_{CJ} is a vertex position of a point (e.g., a first tag) associated with a first joint of the source character, \vec{V}_{AJ} is a vertex position of a point (e.g., a second tag) associated with a corresponding first joint of the target character, \vec{V}_{DJ} is a vertex position of a point (e.g., a corresponding first tag) associated with a second joint of the source character, and \vec{V}_{BJ} is a vertex position of a point (e.g., a corresponding second tag) associated with a corresponding second joint of the target character. For example, the first tag may include “right shoulder” for the source character, the second tag may include “right elbow” for the source character, the corresponding first tag may also include “right shoulder” for the target character, and the corresponding second tag may also include “right elbow” for the target character. The optimization component 116 may then use similar processes for additional sets of points on the source character and/or the target character.

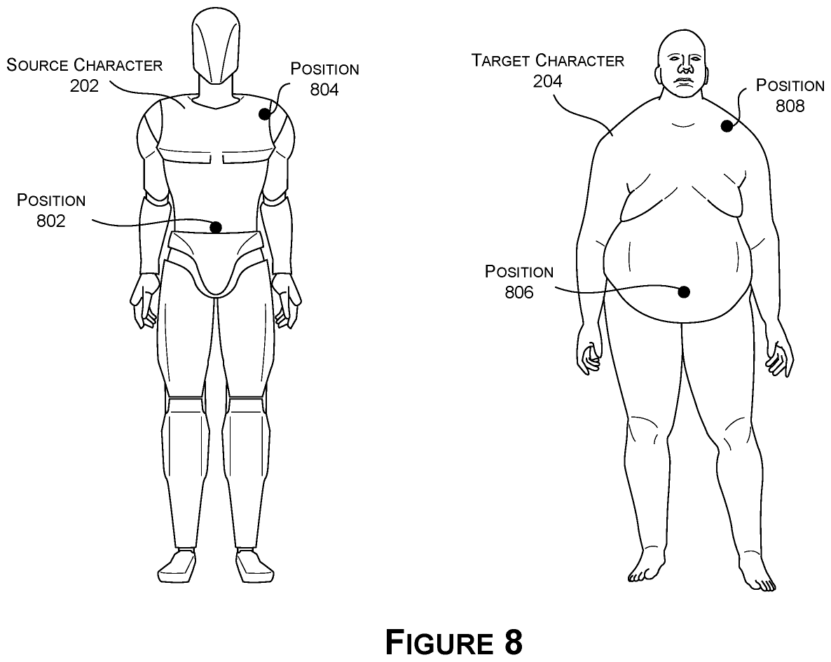

For instance, FIG. 8 illustrates an example of joint constraints associated with animation retargeting, in accordance with some embodiments of the present disclosure. As shown, the optimization component 116 may determine a first set of points that includes a first vertex position 802 (e.g., \vec{V}_{CJ}) of a point associated with a first joint of the source character 202 and a second vertex position 804 (e.g., \vec{V}_{DJ}) of a point associated with a second joint of the source character 202. In some examples, the optimization component 116 may identify the joints as including a pair of joints where no other joint is located between the first joint and the second joint. The optimization component 116 may then determine a second set of points that includes a third vertex position 806 (e.g., \vec{V}_{AJ}) of a point associated with a corresponding first joint of the target character 204 and a fourth vertex position (e.g., \vec{V}_{BJ}) of a point associated with a second corresponding joint of the target character 204. The optimization component 116 may then use the vertex positions 802, 804, 806, and 808 as part of the joint constraint(s) 128 associated with the source character 202 and the target character 204 (e.g., using equation (10)). Additionally, in some examples, the optimization component 116 may perform similar processes for one or more pairs of joints associated with the source character 202 and/or the target character 204.

Referring back to the example of FIG. 1, the process 100 may include the optimization component 116 using one or more optimization techniques 130 in order to optimize the animation retargeting, such as based on one or more of the constraints. In some examples, and as described herein, the optimization component 116 may perform the optimization with respect to one or more joints of the source character and/or the target character. For example, the optimization component 116 may perform the optimization based at least on one or more degrees of freedom associated with the joint(s) of the target character. As described herein, a degree of freedom may be with respect to a rotation associated with a joint, a translation associated with the joint, and/or a location associated with the joint. For instance, an optimization technique 130 may include using the following equation:

$${‖ {\sum }_{{k}_{i}} {α}_{{k}_{i}} {V}_{{k}_{i}} ( θ ) - {p}_{i} ‖}^{2} \qquad ( 11 )$$

As shown, equation (11) includes a general form associated with one or more (e.g., each) of the constraints described herein. For instance, V may include the vertex position vector (Vₓ, V_{y}, V_{z}) associated with a point located on a mesh or a joint of a character, a may be associated with the sets of points where a includes a first value (e.g., −1) for a first point in the set and a second value (e.g., 1) for a second point in the set, pᵢ may include the target value (e.g., the values associated with the source character described herein), and θ may include the rotation(s) and the translation(s) (and/or, in some examples, the location(s)) of the joint(s). In some examples, θ may be in terms of a change in transformation (e.g., a delta transformation), such as from a previous pose associated with the target character. In some examples, the θ may be in terms of a transformation (e.g., a delta transformation) from a retargeting solution acquired using one or more additional and/or alternative algorithms. For example, an additional algorithm(s) may ignore mesh information, such that the additional algorithm(s) works on the skeleton level, to compute an initial estimation of θ. The final θ may then be determined based at least on a delta transformation from the initial estimation of θ, where the θ represents the final delta transformation.

Additionally, in some examples, the rotation(s) and/or the translation(s) (and/or, in some examples, the location(s)) may be constrained. For example, the translation(s) associated with one or more joints scale may be frozen, such as all joints scale except for the root joint. While equation (11) may just include a general form for optimization, the optimization may be performed using one or more of the other optimization equations described herein (e.g., using one or more of the constraints described herein). For example, the optimization may be performed summing one or more of the constraints described herein.

In some examples, the optimization component 116 may perform the optimization using gradient descent, such as by the following:

$${\sum }_{i} {‖ {\sum }_{{k}_{i}} {α}_{{k}_{i}} {V}_{{k}_{i}} ( θ ) - {p}_{i} ‖}^{2} \to \begin{matrix}min \\ θ\end{matrix} \qquad ( 12 )$$

In some examples, the optimization component 116 may use one or more additional operations when performing the optimization. For a first example, the optimization component 116 may assume that one or more joints of the source character include one or more same vertex positions as one or more corresponding joints of the target character. For instance, the optimization component 116 may assume that the hip joint of the source character includes a same vertex position as the hip joint of the target character (e.g., the angle connecting these joints is vertical). For a second example, the optimization component 116 may lock one or more joints, such as by locking the rotation(s), the transformation(s), and/or the location(s) of the joint(s). For a third example, the optimization component 116 may provide one or more weights to one or more of the constraints described herein.

Additionally, as described herein, the optimization component 116 may be performing the optimization for both offline applications and online applications. In some examples, the optimization component 116 may perform the optimization for offline applications by performing these formulations for multiple frames (e.g., every frame) at a single instance. For example, the offline applications may mean that the processing is performed asynchronous and/or not in real-time. In some examples, the optimization component 116 may perform the optimization for online applications by performing the formulations for one or more frames at different instances in time as the optimization component 116 continues to receive new frames for performing animation retargeting. For example, the online applications may mean that the processing is performed synchronous and/or in near real-time and/or real-time. As such, the optimization component 116 may perform one or more additional processes when performing animation targeting for online applications.

For example, the optimization component 116 may add one or more regulation terms such as with the following:

$${\sum }_{i} {‖ {\sum }_{{k}_{i}} {α}_{{k}_{i}} {V}_{{k}_{i}} ( θ ) - {p}_{i} ‖}^{2} + λ * reg ( Q , {Q}_{0} ) \to \begin{matrix}min \\ θ\end{matrix} \qquad ( 13 )$$

In equation (13), the regulation term may restrict θ of a current time instance (e.g., a current frame), such as the rotation(s) associated with the joint(s), such as by using the gradient descent of the previous time instance (e.g., a previous frame). As such, in some examples, the solution for the current time instance may be in absolute value form and/or may be in delta form from the previous time instance. Additionally, or alternatively, in some examples, the θ may be in terms of a transformation (e.g., a delta transformation) from a retargeting solution acquired using one or more additional and/or alternative algorithms. For example, an additional algorithm(s) may ignore mesh information, such that the additional algorithm(s) works on the skeleton level, to compute an initial estimation of θ. The final θ may then be determined based at least on a delta transformation from the initial estimation of θ, where the θ represents the final delta transformation. For example, the final θ may be determined using the initial estimation and/or one or more of the equations described herein, such as equation (13).

For instance, and in the formulas below, the q term may be a delta transform applied on top of a solution coming from a simple solution which does not take the mesh into account. Additionally, one or more regulation terms may be defined as the following:

$$\frac{1}{num\_joints} {\sum }_{j} \vert angle ( {q}_{j} , {q}_{id )} \vert \qquad ( 14 )$$

$$\frac{1}{num\_joints} {\sum }_{j} \vert angle ( {q}_{j}^{t} , {q}_{j}^{t - 1} \vert \qquad ( 15 )$$

In equations (14) and (15), qⱼ is the quaternion of joint j, qⱼ^{t-1} is the quaternion of joint j at a previous frame t−1, and qⱼ^{t} is the quaternion of joint j at a current frame t. In other words, and as discussed further herein, the q term may be in delta form.

The process 100 may include the optimization component 116 generating and/or outputting optimization data 132 representing the animation retargeting associated with the target character. For instance, the optimization data 132 may represent poses associated with the target character at various frames. In some examples, a pose may be associated with vertex positions for various points associated with the target character. In some examples, a computing device (e.g., a user device 110) may then use the optimization data 132 to display the animation retargeting associated with the target character.

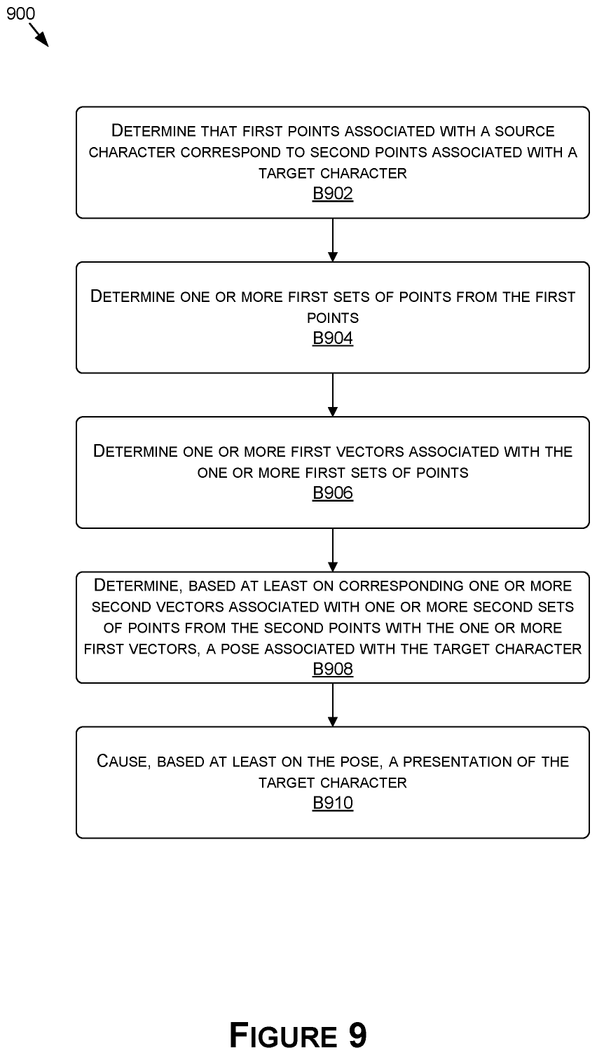

Now referring to FIGS. 9-11, each block of methods 900, 1000, and 1100, described herein, comprises a computing process that may be performed using any combination of hardware, firmware, and/or software. For instance, various functions may be carried out by a processor executing instructions stored in memory. The method 900, 1000, and 1100 may also be embodied as computer-usable instructions stored on computer storage media. The method 900, 1000, and 1100 may be provided by a standalone application, a service or hosted service (standalone or in combination with another hosted service), or a plug-in to another product, to name a few. In addition, the methods 900, 1000, and 1100 are described, by way of example, with respect to FIG. 1. However, these methods 900, 1000, and 1100 may additionally or alternatively be executed by any one system, or any combination of systems, including, but not limited to, those described herein.

FIG. 9 illustrates a flow diagram showing a method 900 for using spatial information for animation retargeting, in accordance with some embodiments of the present disclosure. The method 900, at block B902, may include determining that first points associated with a source character correspond to second points associated with a target character. For instance, the association component 102 may determine that the first points associated with the source character correspond to the second points associated with the target character. As described herein, the association component 102 may determine that the first points correspond to the second points using one or more techniques, such as user inputs and/or processing of the characters.

The method 900, at block B904, may include determining one or more first sets of points from the first points. For instance, the optimization component 116 may determine the first set(s) of points. As described herein, in some examples, the optimization component 116 may determine a first set of points based at least on determining that a distance between the points included in the first set of points satisfies (e.g., is less than) one or more threshold distances 120. In other words, the optimization component 116 may identify the first set(s) of points as including points that are in close proximity with one another.

The method 900, at block B906, may include determining one or more first vectors associated with the one or more first sets of points. For instance, the optimization component 116 may determine the first vector(s) associated with the first set(s) of points. In some examples, the optimization component 116 determines the first vector(s) using the vertex positions of the first points included in the first set(s) of points.

The method 900, at block B908, may include determining, based at least on corresponding one or more second vectors associated with one or more second sets of points from the second points with the one or more first vectors, a pose associated with the target character. For instance, the optimization component 116 may determine the pose associated with the target character by corresponding the second vector(s) associated with the second set(s) of points with the first vector(s) associated with the first set(s) of points. As described herein, the correspondence may be associated with one or more deformation constraints 118. Additionally, in some examples, the optimization component 116 may further determine the pose using additional constraints, such as interaction constraints 122, acceleration constraints 124, feet constraints 126, joint constraints 128, and/or so forth.

The method 900, at block B910, may include causing, based at least on the pose, a presentation of the target character. For instance, the optimization component 116 may generate and/or output the optimization data 132 representing at least the pose. A computing device (e.g., a user device 110) may then use the optimization data 132 to present the target character in the pose. Additionally, in some examples, the method 900 may continue to repeat for determining additional poses associated with the target character for additional frames.

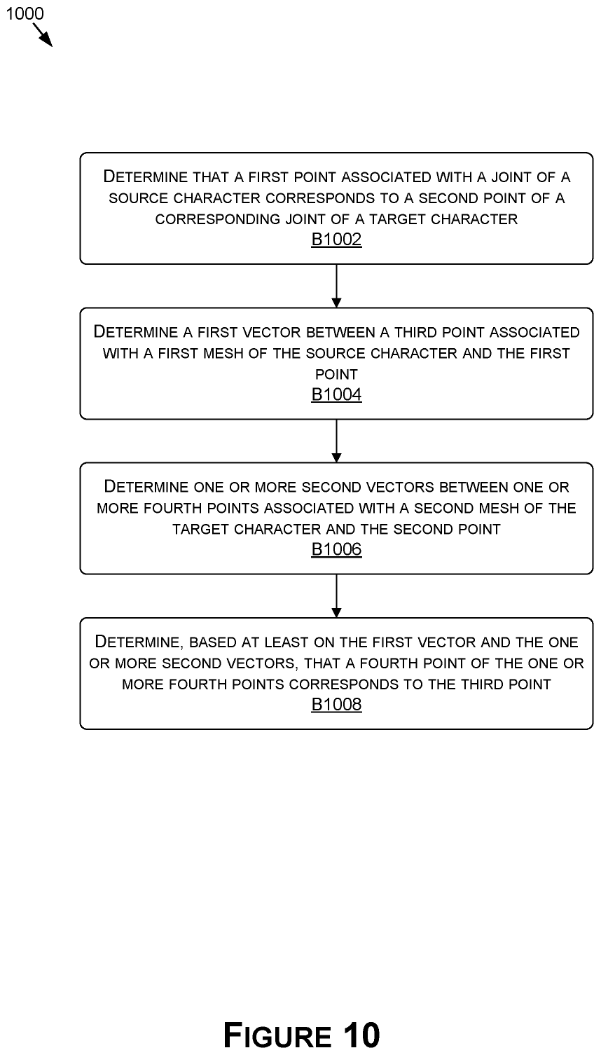

FIG. 10 illustrates a flow diagram showing a method 1000 for determining that points associated with a source character correspond to points associated with a target character, in accordance with some embodiments of the present disclosure. The method 1000, at block B1002, may include determining that a first point associated with a joint of a source character corresponds to a second point of a corresponding joint of a target character. For instance, the association component 102 may determine that the first point associated with the joint of the source character corresponds to the second point of the corresponding joint of the target character. In some examples, the association component 102 may make the determination based at least on receiving inputs indicating a similar tag for the joints.

The method 1000, at block B1004, may include determining a first vector between a third point associated with a first mesh of the source character and the first point. For instance, the association component 102 may determine the first vector between the third point associated with the first mesh of the source character and the first point. In some examples, the association component 102 makes the determination based at least on a vertex position associated with the first point and a vertex position associated with the third point.

The method 1000, at block B1006, may include determining one or more second vectors between one or more fourth points associated with a second mesh of the target character and the second point. For instance, the association component 102 may determine the second vector(s) between the fourth point(s) associated with the second mesh of the target character and the second point. In some examples, the association component 102 makes the determination based at least on a vertex position associated with the second point and one or more vertex positions associated with the fourth point(s).

The method 1000, at block B1008, may include determining, based at least on the first vector and the one or more second vectors, that a fourth point of the one or more fourth points corresponds to the third point. For instance, the association component 102 may determine that the fourth point corresponds to the third point based at least on the first vector and the second vector(s). In some examples, the association component 102 makes the determination based at least on the fourth point being associated with a closest vector to the first vector from among the second vector(s).

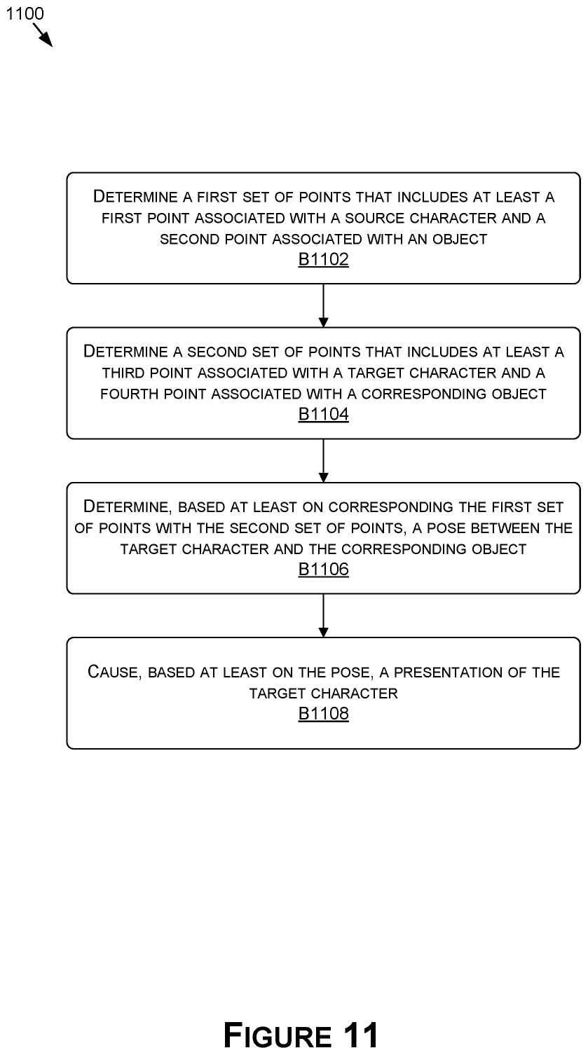

FIG. 11 illustrates a flow diagram showing a method 1100 for using spatial information for animation retargeting between characters and objects, in accordance with some embodiments of the present disclosure. The method 1100, at block B1102, may include determining a first set of points that includes at least a first point associated with a source character and a second point associated with an object. For instance, the optimization component 116 may determine the first set of points that includes the first point associated with the source character and the second point associated with the object. In some examples, the optimization component 116 may determine the first set of points based at least on determining that a distance between the points included in the first set of points satisfies (e.g., is less than) one or more threshold distances 120. In other words, the optimization component 116 may identify the first set of points as including points that are in close proximity with one another.

The method 1100, at block B1104, may include determining a second set of points that includes at least a third point associated with a target character and a fourth point associated with a corresponding object. For instance, the optimization component 116 may determine the second set of point that includes the third point associated with the target character and the fourth point associated with the corresponding object. In some examples, the optimization component 116 may determine the second set of points based at least on the third point corresponding to the first point and the fourth point corresponding to the second point.

The method 1100, at block B1106, may include determining, based at least on corresponding the first set of points with the second set of points, a pose between the target character and the corresponding object. For instance, the optimization component 116 may determine the pose based at least on corresponding the first set of points to the second set of points. In some examples, the optimization component 116 performs the correspondence by optimizing a first vector associated with the first set of points with a second vector associated with the second set of points. In some examples, the optimization component 116 performs the optimization in joint space, which is described herein.

The method 1100, at block B1108, may include causing, based at least on the pose, a presentation of the target character. For instance, the optimization component 116 may generate and/or output the optimization data 132 representing at least the pose. A computing device (e.g., a user device 110) may then use the optimization data 132 to present the target character in the pose. Additionally, in some examples, the method 1100 may continue to repeat for determining additional poses associated with the target character for additional frames.

### Example Content Streaming System

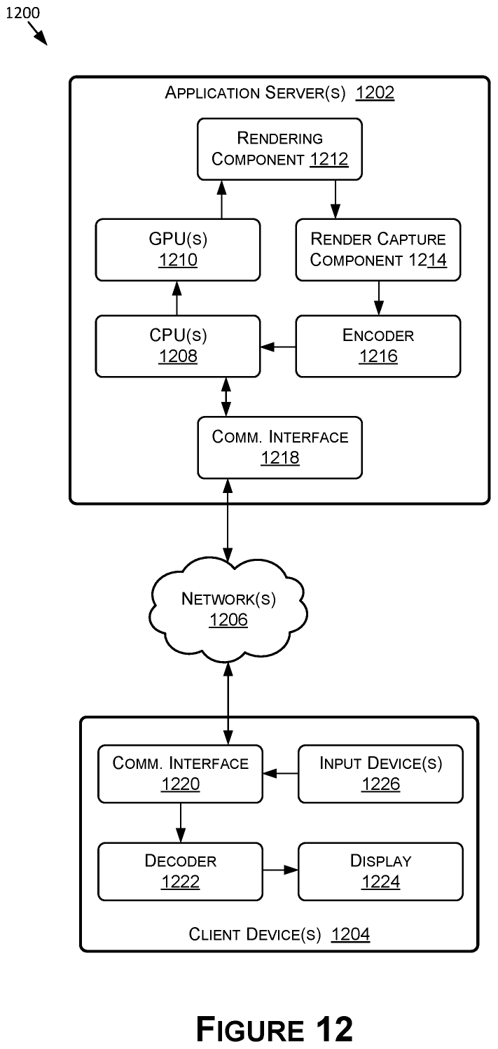

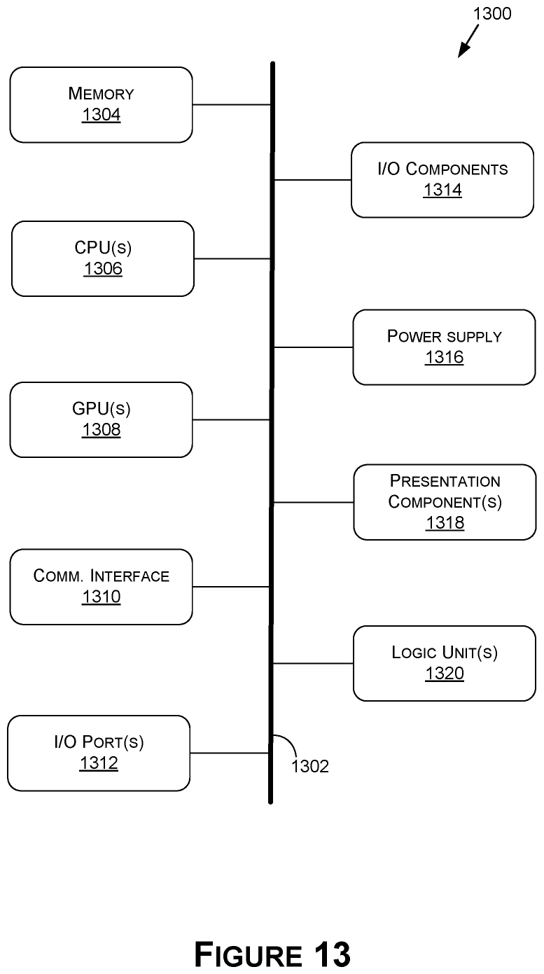

Now referring to FIG. 12, FIG. 12 is an example system diagram for a content streaming system 1200, in accordance with some embodiments of the present disclosure. FIG. 12 includes application server(s) 1202 (which may include similar components, features, and/or functionality to the example computing device 1300 of FIG. 13), client device(s) 1204 (which may include similar components, features, and/or functionality to the example computing device 1300 of FIG. 13), and network(s) 1206 (which may be similar to the network(s) described herein). In some embodiments of the present disclosure, the system 1200 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1200, for an application session, the client device(s) 1204 may only receive input data in response to inputs to the input device(s), transmit the input data to the application server(s) 1202, receive encoded display data from the application server(s) 1202, and display the display data on the display 1224. As such, the more computationally intense computing and processing is offloaded to the application server(s) 1202 (e.g., rendering—in particular ray or path tracing—for graphical output of the application session is executed by the GPU(s) of the game server(s) 1202). In other words, the application session is streamed to the client device(s) 1204 from the application server(s) 1202, thereby reducing the requirements of the client device(s) 1204 for graphics processing and rendering.

For example, with respect to an instantiation of an application session, a client device 1204 may be displaying a frame of the application session on the display 1224 based on receiving the display data from the application server(s) 1202. The client device 1204 may receive an input to one of the input device(s) and generate input data in response. The client device 1204 may transmit the input data to the application server(s) 1202 via the communication interface 1220 and over the network(s) 1206 (e.g., the Internet), and the application server(s) 1202 may receive the input data via the communication interface 1218. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1212 may render the application session (e.g., representative of the result of the input data) and the render capture component 1214 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 1202. In some embodiments, one or more virtual machines (VMs)—e.g., including one or more virtual components, such as vGPUs, vCPUs, etc.—may be used by the application server(s) 1202 to support the application sessions. The encoder 1216 may then encode the display data to generate encoded display data and the encoded display data may be transmitted to the client device 1204 over the network(s) 1206 via the communication interface 1218. The client device 1204 may receive the encoded display data via the communication interface 1220 and the decoder 1222 may decode the encoded display data to generate the display data. The client device 1204 may then display the display data via the display 1224.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### Example Data Center

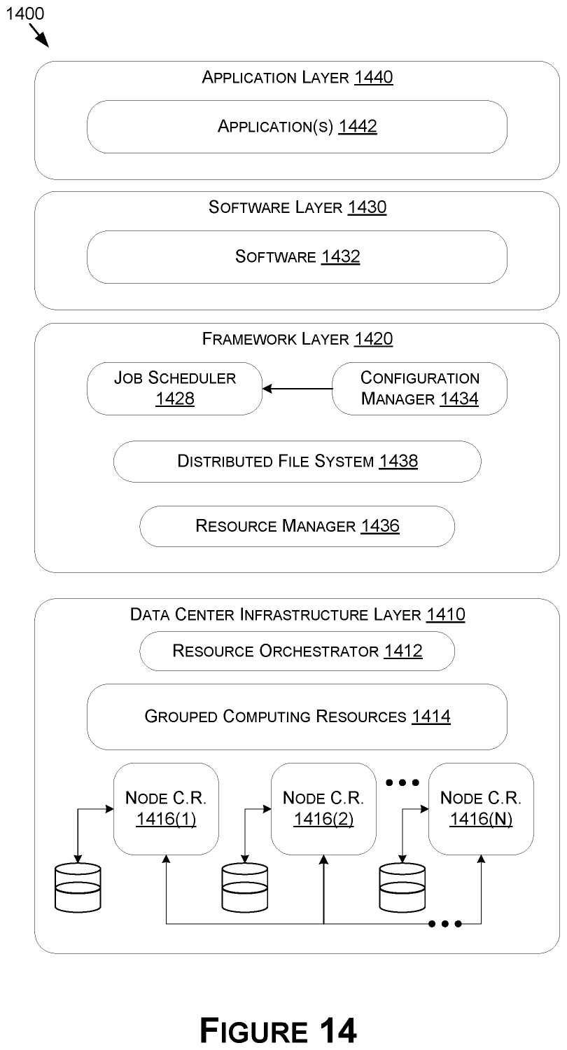

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161(N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1428, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1428 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1428. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Clauses

A: A method comprising: determining first points associated with a source character that correspond to second points associated with a target character; determining one or more first sets of points from the first points; determining one or more first vectors associated with the one or more first sets of points; determining, based at least on adjusting one or more second vectors associated with one or more second sets of points from the second points to correspond with the one or more first vectors, a pose associated with the target character; and causing, based at least on the pose, a presentation of the target character.

B: The method of paragraph A, wherein the determining a set of points from the one or more first sets of points comprises: determining a distance between a first point and a second point from the set of points; and determining that the distance is less than a threshold distance.

C: The method of paragraph A or paragraph B, wherein the determining a set of points from the one or more first sets of points comprises: determining a first distance between a first point and a second point from the set of points when the source character is at a current pose; determining a second distance between the first point and the second point when the source character is at a set pose; determining a third distance based at least on the first distance and the second distance; and determining that the third distance is less than a threshold distance.

D: The method of any one of paragraphs A-C, wherein the determining that the first points correspond to the second points comprises: determining one or more first points from the first points that are associated with one or more joint tags; determining one or more second points from the second points that are associated with the one or more joint tags; and determining, based at least on the one or more joint tags, that the one or more first points correspond to the one or more second points.

E: The method of any one of paragraphs A-D, wherein the determining that a first point from the first points corresponds to a second point from the second points comprises: determining a first vector between the first point associated with a first mesh of the source character and a third point from the first points, the third point associated with a first joint of the source character; determining a second vector between the second point associated with a second mesh of the target character and a fourth point from the second points, the fourth point associated with a second joint of the target character that corresponds to the first joint of the source character; and determining that the first point corresponds to the second point based at least the first vector and the second vector.

F: The method of any one of paragraphs A-E, wherein the determining the pose associated with the target character comprises: performing an optimization operation with respect to one or more degrees of freedom associated with one or more joints of the target character such that the one or more second vectors correspond to the one or more first vectors; and determining the pose associated with the target character based at least the one or more degrees of freedom as determined during the optimization operation.

G: The method of paragraph F, wherein the optimization operation includes gradient descent.

H: The method of any one of paragraphs A-G, further comprising: determining one or more third sets of points between the source character and a first object; determining one or more third vectors associated with the one or more third sets of points; and determining, based at least on the one or more third sets of points, one or more fourth sets of points between the target character and a second object that corresponds to the first object, wherein the determining the pose associated with the target character is further based at least on adjusting one or more fourth vectors associated with the one or more fourth sets of points to correspond with the one or more third vectors.

I: The method of any one of paragraphs A-H, further comprising: determining that a first point from the first points is static between a first frame and a second frame, wherein the first point is associated with a foot of the source character; determining a first location of a second point from the second points at the first frame, the second point corresponding to the first point; and determining a second location of the second point at a second frame, wherein the determining the pose associated with the target character is further based at least on the first location and the second location.

J: The method of any one of paragraphs A-I, further comprising: determining one or more third sets of points from the first points that are associated with joints of the source character; determining one or more third vectors associated with the one or more third sets of points; and determining one or more fourth sets of points from the second points that correspond to the one or more third sets of points, wherein the determining the pose associated with the target character is further based at least on adjusting one or more fourth vectors associated with one or more fourth sets of points to correspond with the one or more third vectors.

K: A system comprising: one or more processors to: determine one or more first sets of points associated with a first mesh of a source character; determine, based at least on the one or more first sets of points, one or more second sets of points associated with a second mesh of a target character; determine, based at least on performing an optimization operation with respect to one or more joints of the target character using the one or more first sets of points and the one or more second sets of points, a pose associated with the target character; and cause, based at least on the pose, a presentation of the target character.

L: The system of paragraph K, wherein the determination of a set of points from the one or more first sets of points comprises: determining a distance between a first point and a second point from the set of points; and determining that the distance is less than one or more threshold distances.

M: The system of paragraph K or paragraph L, wherein the determination of a set of points from the one or more first sets of points comprises: determining a first distance between a first point and a second point from the set of points when the source character is at a current pose; determining a second distance between the first point and the second point when the source character is at a set pose; determining a third distance based at least on the first distance and the second distance; and determining that the third distance is less than a threshold distance.

N: The system of any one of paragraphs K-M, wherein the determination that the one or more second sets of points correspond to the one or more first sets of points is based at least on at least one of: one or more inputs indicating that first points from the one or more first sets of points correspond to second points from the one or more second sets of points; or determining that one or more first vectors between the first points and one or more joint points associated with the source character correspond to one or more second vectors between the second points and one or more corresponding joint points associated with the target character.

O: The system of any one of paragraph K-N, wherein the determination of the pose associated with the target character comprises: performing an optimization operation with respect to one or more degrees of freedom associated with the one or more joints of the target character such that one or more first vectors associated with the one or more first sets of points correspond to one or more second vectors associated with the one or more second sets of points; and determining the pose associated with the target character based at least the one or more degrees of freedom as determined during the optimization operation.

P: The system of any one of paragraphs K-O, wherein the one or more processors are further to: determine one or more third sets of points between the source character and a first object; and determine, based at least on the one or more third sets of points, one or more fourth sets of points between the target character and a second object that corresponds to the first object; wherein the determination of the pose associated with the target character is further based at least on the one or more third sets of points and the one or more fourth sets of points.

Q: The system of any one of paragraphs K-P, wherein the one or more processors are further to: determine that a third point associated with a foot of the source character is static between a previous frame and a current frame; based at least on the third point being static, determine a first location of a fourth point associated with the target character in the previous frame, the fourth point corresponding to the third point; and determine a second location of the fourth point in the current frame, wherein the determination of the pose associated with the target character is further based at least on the first location and the second location.

R: The system of any one of paragraphs K-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing one or more conversational AI operations; a system for generating synthetic data; a system associated with a gaming application; a system associated with a three-dimensional content application; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to generate an animation of a target character in a pose corresponding to a source character based at least on adjusting one or more joints associated with the target character using one or more first sets of points associated with a first mesh of the source character and one or more second sets of points associated with a second mesh of the target character.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing one or more conversational AI operations; a system for generating synthetic data; a system associated with a gaming application; a system associated with a three-dimensional content application; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining first points associated with a source character that correspond to second points associated with a target character;
determining one or more first sets of points from the first points;
determining one or more first vectors associated with the one or more first sets of points;
determining, based at least on adjusting one or more second vectors associated with one or more second sets of points from the second points to correspond with the one or more first vectors, a pose associated with the target character; and
causing, based at least on the pose, a presentation of the target character.

2. The method of claim 1, wherein the determining a set of points from the one or more first sets of points comprises:
determining a distance between a first point and a second point from the set of points; and
determining that the distance is less than a threshold distance.

3. The method of claim 1, wherein the determining a set of points from the one or more first sets of points comprises:
determining a first distance between a first point and a second point from the set of points when the source character is at a current pose;
determining a second distance between the first point and the second point when the source character is at a set pose;
determining a third distance based at least on the first distance and the second distance; and
determining that the third distance is less than a threshold distance.

4. The method of claim 1, wherein the determining that the first points correspond to the second points comprises:
determining one or more first points from the first points that are associated with one or more joint tags;
determining one or more second points from the second points that are associated with the one or more joint tags; and
determining, based at least on the one or more joint tags, that the one or more first points correspond to the one or more second points.

5. The method of claim 1, wherein the determining that a first point from the first points corresponds to a second point from the second points comprises:
determining a first vector between the first point associated with a first mesh of the source character and a third point from the first points, the third point associated with a first joint of the source character;
determining a second vector between the second point associated with a second mesh of the target character and a fourth point from the second points, the fourth point associated with a second joint of the target character that corresponds to the first joint of the source character; and
determining that the first point corresponds to the second point based at least the first vector and the second vector.

6. The method of claim 1, wherein the determining the pose associated with the target character comprises:
performing an optimization operation with respect to one or more degrees of freedom associated with one or more joints of the target character such that the one or more second vectors correspond to the one or more first vectors; and
determining the pose associated with the target character based at least the one or more degrees of freedom as determined during the optimization operation.

7. The method of claim 6, wherein the optimization operation includes gradient descent.

8. The method of claim 1, further comprising:
determining one or more third sets of points between the source character and a first object;
determining one or more third vectors associated with the one or more third sets of points; and
determining, based at least on the one or more third sets of points, one or more fourth sets of points between the target character and a second object that corresponds to the first object,
wherein the determining the pose associated with the target character is further based at least on adjusting one or more fourth vectors associated with the one or more fourth sets of points to correspond with the one or more third vectors.

9. The method of claim 1, further comprising:
determining that a first point from the first points is static between a first frame and a second frame, wherein the first point is associated with a foot of the source character;
determining a first location of a second point from the second points at the first frame, the second point corresponding to the first point; and
determining a second location of the second point at a second frame,
wherein the determining the pose associated with the target character is further based at least on the first location and the second location.

10. The method of claim 1, further comprising:
determining one or more third sets of points from the first points that are associated with joints of the source character;
determining one or more third vectors associated with the one or more third sets of points; and
determining one or more fourth sets of points from the second points that correspond to the one or more third sets of points,
wherein the determining the pose associated with the target character is further based at least on adjusting one or more fourth vectors associated with one or more fourth sets of points to correspond with the one or more third vectors.

11. A system comprising:
one or more processors to:
determine one or more first sets of points associated with a first mesh of a source character;
determine, based at least on the one or more first sets of points, one or more second sets of points associated with a second mesh of a target character;
determine, based at least on performing an optimization operation with respect to one or more joints of the target character using the one or more first sets of points and the one or more second sets of points, a pose associated with the target character; and
cause, based at least on the pose, a presentation of the target character.

12. The system of claim 11, wherein the determination of a set of points from the one or more first sets of points comprises:
determining a distance between a first point and a second point from the set of points; and
determining that the distance is less than one or more threshold distances.

13. The system of claim 11, wherein the determination of a set of points from the one or more first sets of points comprises:
determining a first distance between a first point and a second point from the set of points when the source character is at a current pose;
determining a second distance between the first point and the second point when the source character is at a set pose;
determining a third distance based at least on the first distance and the second distance; and
determining that the third distance is less than a threshold distance.

14. The system of claim 11, wherein the determination that the one or more second sets of points correspond to the one or more first sets of points is based at least on at least one of:
one or more inputs indicating that first points from the one or more first sets of points correspond to second points from the one or more second sets of points; or
determining that one or more first vectors between the first points and one or more joint points associated with the source character correspond to one or more second vectors between the second points and one or more corresponding joint points associated with the target character.

15. The system of claim 11, wherein the determination of the pose associated with the target character comprises:
performing an optimization operation with respect to one or more degrees of freedom associated with the one or more joints of the target character such that one or more first vectors associated with the one or more first sets of points correspond to one or more second vectors associated with the one or more second sets of points; and
determining the pose associated with the target character based at least the one or more degrees of freedom as determined during the optimization operation.

16. The system of claim 11, wherein the one or more processors are further to:
determine one or more third sets of points between the source character and a first object; and
determine, based at least on the one or more third sets of points, one or more fourth sets of points between the target character and a second object that corresponds to the first object;
wherein the determination of the pose associated with the target character is further based at least on the one or more third sets of points and the one or more fourth sets of points.

17. The system of claim 11, wherein the one or more processors are further to:
determine that a third point associated with a foot of the source character is static between a previous frame and a current frame;
based at least on the third point being static, determine a first location of a fourth point associated with the target character in the previous frame, the fourth point corresponding to the third point; and
determine a second location of the fourth point in the current frame,
wherein the determination of the pose associated with the target character is further based at least on the first location and the second location.

18. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing one or more conversational AI operations;
a system for generating synthetic data;
a system associated with a gaming application;
a system associated with a three-dimensional content application;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to generate an animation of a target character in a pose corresponding to a source character based at least on adjusting one or more joints associated with the target character using one or more first sets of points associated with a first mesh of the source character and one or more second sets of points associated with a second mesh of the target character.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing one or more conversational AI operations;
a system for generating synthetic data;
a system associated with a gaming application;
a system associated with a three-dimensional content application;
a system for presenting at least one of virtual reality content, augmented reality content, or mixed reality content;
a system incorporating one or more virtual machines (VMs);
a system implemented at least partially in a data center, or
a system implemented at least partially using cloud computing resources.
